(19) United States
(12) Patent Application Publication
(10) Pub. No.: US 2025/0368427 A1
(43) Pub. Date: Dec. 4, 2025

(54) TRANSPORT PLATFORM ASSEMBLY AND METHOD

(71) Applicants: Gareth William Menzies as trustee for GM Trust, Maryborough West (AU); Timothy Menzies as trustee for TM Trust, Maryborough West (AU); Stephen William Menzies as trustee for SWM Trust, Maryborough West (AU); Richard George Menzies as trustee for RGM Trust, Maryborough West (AU); CLEW Holdings Group Pty Ltd as trustee for CLEW Holdings Group Trust, Maryborough West (AU); WPH Holdings Group Pty Ltd as trustee for WPH Holdings Group Trust, Maryborough West (AU); Suvla Properties Pty Ltd as trustee for Minippi Trust, Mount Gravatt (AU)

(72) Inventors: Raymond EADE, Maryborough West (AU); Samuel POIKAYIL, Maryborough West (AU)

(21) Appl. No.: 19/227,897

(22) Filed: Jun. 4, 2025

(30) Foreign Application Priority Data
Jun. 4, 2024 (AU) 2024901685

(51) Int. Cl. B65D 88/12; B65D 90/00; B65D 90/02

(52) U.S. Cl. CPC B65D 88/127; B65D 90/0026; B65D 90/023

(57) ABSTRACT

A transport platform assembly for loading, conveying and storing loads, the transport platform assembly comprising: a load receiving platform to receive a load thereon, a generally rectangular structural frame configured to support the load receiving platform and comprising frame members defining sides of the structural frame, and corner portions each comprising a corner fitting for permitting the transport platform assembly to be secured onto a receiving arrangement associated with a transport vehicle.

### TECHNICAL FIELD

The present invention relates to a transport platform assembly for loading, conveying and storing loads.

In particular, the present invention relates to a transport platform assembly for loading, conveying and storing loads, a method of coupling a canopy assembly to a transport platform assembly for loading, conveying and storing loads, and methods for conveying loads, which loads may be large discrete loads such as large pumps, motors and other equipment.

### BACKGROUND

Any references to methods, apparatus or documents of the prior art are not to be taken as constituting any evidence or admission that they formed, or form part of the common general knowledge.

It is common practice for loads such as large pumps and motors to be mounted onto pallets. Typically, the load is securably mounted onto the pallet and lifting equipment such as forklifts are used for lifting the loaded pallet onto the tray of a semi-trailer. Once the pallet is placed on the tray, manual handling is required to secure the loaded pallet onto the tray. Typically, the pallet may comprise elements for receiving lashing straps that can be secured to anchor points on the tray of the semi-trailer. Straps, chains and other securing devices can be attached to anchor points, also called lashing eyes or lashing points that can provided on the pallet and at various locations along the tray of the semi-trailer. In order to carry out the task of manually anchoring the lashing straps, or chains or other devices with the loaded pallet and the semi-trailer, the personnel may typically climb onto the tray of the semi-trailer, stand at ground level and reach to place or throw the lashing device over the load, or use an elevated platform to reach the load and complete load restraint. Safe handing while securing loads on semi-trailers is an important issue that needs to be addressed. Safe and secure handling can also be time-consuming which can make these tasks somewhat inefficient.

In view of these underlying requirements, it would be desirable to provide a transport platform assembly for loading, conveying and storing loads, a method of coupling a canopy assembly to a transport platform assembly for loading, conveying and storing loads, and/or a method for conveying loads that at least partially ameliorates and/or overcomes drawbacks associated with existing methods, and/or at least provides the pubic with a useful alternative.

### SUMMARY OF INVENTION

In a first aspect, the invention provides a transport platform assembly for loading, conveying and storing loads, the transport platform assembly comprising: a load receiving platform having a planar upper surface configured to receive a load thereon; a generally rectangular structural frame configured to support the load receiving platform and comprising first and second longitudinal frame members and third and fourth transverse frame members that intersect each other to form respective first to forth longitudinal and transverse sides of the structural frame; and a strengthening member located substantially in a middle region of the load receiving platform and extending along a length thereof, the strengthening member being provided to present at least one inboard lashing feature below the upper surface of the load receiving platform for securing any loads positioned thereon to the transport platform assembly, the structural frame further comprising corner portions each comprising a corner fitting for permitting the transport platform assembly to be secured onto a receiving arrangement associated with a transport vehicle.

In an embodiment, the load receiving platform comprises at least one access aperture extending therethrough for permitting access to the inboard lashing feature below the upper surface thereof.

In an embodiment, the at least one access aperture comprises a plurality of access apertures arranged in a linear array along the load receiving platform and proximately above the inboard lashing feature.

In an embodiment, the inboard lashing feature comprises a inboard elongate lashing member extending centrally longitudinally along at least a portion of the strengthening member.

In an embodiment, the strengthening member comprises at least one inboard support rib extending transversely across the inboard elongate lashing member and configured to support the inboard elongate lashing member.

In an embodiment, the strengthening member is located centrally relative to the longitudinal sides of the rectangular frame.

In an embodiment, the at least one inboard support rib is positioned proximate at least one access aperture of the load receiving platform, so as to provide rigidity to the portion of the inboard elongate lashing member when employed in use to secure any loads positioned on the load receiving platform to the transport platform assembly.

In an embodiment, the inboard lashing feature, inboard elongate lashing member and/or inboard support rib may be located substantially in a middle region of the transport platform assembly.

In an embodiment, a plurality of strengthening members may be located generally about the middle region of the transport platform assembly, each presenting at least one inboard lashing feature.

In an embodiment, the plurality of strengthening members are aligned axially in a column extending along the length of the transport platform assembly.

In an embodiment, the plurality of strengthening members are oriented axially offset from one another.

In an embodiment, any one of the plurality of strengthening members is positioned more, or less, proximate any one or more of the sides of the structural frame relative any other strengthening member of the plurality of strengthening members.

In an embodiment, the structural frame comprises at least one periphery lashing feature located proximate the sides of the structural frame and below the load receiving platform for securing any loads positioned thereon to the transport platform assembly.

In an embodiment, the structural frame comprises at least one access aperture for permitting access to the periphery lashing feature.

In an embodiment, the periphery lashing feature comprises a periphery elongate lashing member extending along at least a portion of any one or more of the frame members.

In an embodiment, the structural frame comprises at least one periphery support rib extending transversely across the periphery elongate lashing member and configured to support the periphery elongate lashing member.

In an embodiment, the at least one periphery support rib is positioned proximate at least one access aperture of the structural frame, so as to provide rigidity to the portion of the periphery elongate lashing member when employed in use to secure any loads positioned on the load receiving platform to the transport platform assembly.

In an embodiment, the periphery lashing feature further comprises a periphery cross lashing member extending across at least a portion of any one or more of the frame members.

In an embodiment, the periphery cross lashing member forms an upper portion of the at least one periphery support rib.

In an embodiment, the structural frame comprises two or more spaced apart openings located below the load receiving platform, the openings extending longitudinally and/or transversally across the structural frame and configured to receive tines of a forklift.

In an embodiment, the transport platform assembly comprises a plurality of mating features arranged about the load receiving platform and/or structural frame, the transport platform assembly further comprising canopy assembly comprising at least one wall module and at least one ceiling module and a plurality of complementary features adapted to interface with corresponding mating features the transport platform assembly, so as to form the canopy assembly atop the transport platform assembly.

In an embodiment, the transport platform assembly and canopy assembly are together configured such that each of the wall module and ceiling module can be sequentially mated to the transport platform assembly for so forming the canopy assembly.

In an embodiment, the transport platform assembly and canopy assembly are together configured to permit said sequential mating to the transport platform assembly, while said transport platform assembly is secured to the receiving arrangement.

In an embodiment, the mating features comprise a vertical elongate tube receptacle and/or a primary receiving hole arranged about the sides of the structural frame, and wherein the complementary features comprise a downwardly extending locating tube and/or a through hole arranged about a bottom of the at least one wall module.

In an embodiment, the vertical elongate tube receptacle extends at least partly through, and wherein the primary receiving hole is located on an upper surface of, any one or more of the frame members.

In an embodiment, the mating features comprise an auxiliary receiving hole coaxial the primary receiving hole and located on a flange member positioned beneath the upper surface of any one or more of the frame members.

In an embodiment, the flange member is located within a channel of any one or more of the frame members.

In an embodiment, the mating features and complementary features are configured to receive at least one fastener for extending through each of the through hole, primary receiving hole and auxiliary receiving hole, each coaxially aligned when coupling the wall module to the transport platform assembly.

In an embodiment, the mating features further comprise a twist lock receiving aperture located on any of the corner portions, and wherein the complementary features further comprise a twist lock receiving slot at the bottom of the at least one wall module.

In an embodiment, the twist lock receiving aperture and twist lock receiving slot are configured to coaxially align when mating the wall module to the transport platform assembly so as to together receive a twist lock positioned vertically in use and extending therethrough for securing the wall module to the transport platform assembly.

In an embodiment, the canopy assembly comprises coupling features for interfacing and connecting the at least one ceiling module to the at least one wall module and comprising at least one coupling hole arranged at a top surface of the at least one wall module, at least one coupling flange positioned beneath the top surface of the wall module and comprising a supporting hole coaxial the coupling hole, and at least one ceiling hole located about a bottom surface of the ceiling module.

In an embodiment, the coupling features is configured to receive at least one fastener for extending through each of the ceiling hole, coupling hole and supporting hole which are coaxially aligned when coupling the ceiling module to the wall module, for coupling thereof.

In an embodiment, the transport platform assembly may comprises a plurality of mating features arranged about the load receiving platform and/or structural frame, and further comprising a canopy assembly comprising at least one wall and at least one ceiling connected or unitarily formed together, and configured for connecting to the transport assembly by way of a plurality of complementary features thereof adapted to interface with corresponding mating features.

In an embodiment, the mating and complementary features comprise any one or more of the aforementioned embodiments.

In an embodiment, the transport platform assembly is configured so that it is stackable to form a plurality of transport platform assemblies arranged atop one another, the corner fittings thereof configured to secure each transport platform assembly of the plurality of transport platform assemblies to an adjacent transport platform assembly.

In an embodiment, the corner portions are configured to receive a lifting attachment of a lifting apparatus such that the plurality of transport platform assemblies are together movable from at least four corner portions of the plurality of transport platform assemblies.

In an embodiment, the plurality of transport platform assemblies are movable by at least four corner portions thereof, when they are in a substantially horizontal orientation with the upper surfaces of their load receiving platforms oriented substantially horizontally, and/or in a substantially vertical orientation with their upper surfaces oriented substantially vertically.

In an embodiment, the corner fittings comprise a twist lock arrangement configured to receive a twist lock for securing the transport platform assembly to corresponding locking arrangements of the receiving arrangement.

In a second aspect, the invention provides a method of coupling a canopy assembly to a transport platform assembly for loading, conveying and storing loads, the transport platform assembly comprising a load receiving platform, a generally rectangular structural frame supporting the load receiving platform and comprising frame members defining sides of the structural frame, a plurality of mating features located about the frame members, and corner portions each comprising a corner fitting for connecting the transport platform assembly to a receiving arrangement of a transport vehicle, the method comprising: locating the canopy assembly above the transport platform assembly, positioning the canopy assembly such that complimentary features located about a bottom thereof are aligned with corresponding mating features at a side of the of the structural frame, and lowering the canopy assembly atop the transport platform assembly and coupling the mating and complimentary features together so as to connect the canopy assembly to the transport platform assembly.

In an embodiment, said coupling of the mating and complimentary features comprises arranging a fastener to extend through a primary receiving hole arranged about a side of the transport platform assembly and a through hole of the wall at a bottom thereof, and bolting it to said primary receiving hole and said through hole.

In an embodiment, said coupling of the mating and complimentary features comprises inserting a locating tube of the wall extending downwardly from the bottom thereof, into a vertical elongate tube receptacle arranged about a side of the transport platform assembly.

In an embodiment, said coupling of the mating and complimentary features comprises arranging a twist lock at and coaxially aligning it with a twist lock receiving aperture located on any of the corner portions and a twist lock receiving slot at the bottom of the wall, and locking it to said twist lock receiving aperture and said twist lock receiving slot.

In an embodiment, the canopy assembly comprises at least one wall module and at least one ceiling module and wherein the transport platform assembly and canopy assembly are together configured such that each of the wall module and ceiling module can be sequentially mated to the transport platform assembly for so forming the canopy assembly.

In an embodiment, the method comprises the further steps of: locating a first wall module of the canopy assembly above a side of the structural frame; positioning the wall module such that complimentary features located about a bottom of the wall module are aligned with corresponding mating features at the side; lowering the wall module atop the transport platform assembly and coupling the mating and complimentary features together so as to connect the wall module to the side of the transport platform assembly; locating a second wall module of the canopy assembly above another side of the structural frame; positioning the second wall module such that complimentary features located about a bottom of the second wall module are aligned with corresponding mating features at the other side; lowering the second wall module atop the transport platform assembly and coupling the mating and complimentary features together so as to connect the second wall module to the other side of the transport platform assembly; locating a ceiling module of the canopy assembly above the so connected first and second wall modules; positioning the ceiling module such that coupling features of the ceiling module and of each of the first and second wall modules are aligned; and lowering the ceiling module and connecting the coupling features so as to connect the ceiling module to the so connected first and second wall modules.

In an embodiment, said coupling of the mating and complimentary features comprises arranging a fastener to extend through a primary receiving hole arranged about a side of the transport platform assembly and a through hole of the first or second wall module located at a bottom thereof, and bolting it to said primary receiving hole and said through hole.

In an embodiment, said coupling of the mating and complimentary features comprises inserting a locating tube of the first or second wall module extending downwardly from the bottom thereof, into a vertical elongate tube receptacle arranged about a side of the transport platform assembly.

In an embodiment, said coupling of the mating and complimentary features comprises arranging a twist lock at and coaxially aligning it with a twist lock receiving aperture located on any of the corner portions and a twist lock receiving slot at the bottom of the first or second wall module, and locking it to said twist lock receiving aperture and said twist lock receiving slot.

In an embodiment, said connecting of the coupling features to connect the ceiling module to the so connected first and second wall modules comprises arranging a fastener to extend through a coupling hole arranged at a top surface of the first or second wall module, and a ceiling hole located about a bottom surface of the ceiling module, and bolting it to said coupling hole and ceiling hole.

Disclosed herein is a method of coupling a canopy assembly to a transport platform assembly for loading, conveying and storing loads, the transport platform assembly comprising a load receiving platform, a generally rectangular structural frame supporting the load receiving platform and comprising frame members defining sides of the structural frame, a plurality of mating features located about the frame members, and corner portions each comprising a corner fitting for connecting the transport platform assembly to a receiving arrangement of a transport vehicle, the method comprising: locating a first wall module of the canopy assembly above a side of the structural frame; positioning the wall module such that complimentary features located about a bottom of the wall module are aligned with corresponding mating features at the side; lowering the wall module atop the transport platform assembly and coupling the mating and complimentary features together so as to connect the wall module to the side of the transport platform assembly; locating a second wall module of the canopy assembly above another side of the structural frame; positioning the second wall module such that complimentary features located about a bottom of the second wall module are aligned with corresponding mating features at the other side; lowering the second wall module atop the transport platform assembly and coupling the mating and complimentary features together so as to connect the second wall module to the other side of the transport platform assembly; locating a ceiling module of the canopy assembly above the so connected first and second wall modules; positioning the ceiling module such that coupling features of the ceiling module and of each of the first and second wall modules are aligned; and lowering the ceiling module and connecting the coupling features so as to connect the ceiling module to the so connected first and second wall modules.

In an embodiment, the method further comprises any one or more of the aforementioned embodiments of the second aspect.

Disclosed herein is a method of coupling a unitarily arranged canopy assembly to a transport platform assembly for loading, conveying and storing loads, the unitarily arranged canopy assembly comprising at least one wall and at least one ceiling connected or unitarily formed together, and the transport platform assembly comprising a load receiving platform, a generally rectangular structural frame supporting the load receiving platform and comprising frame members defining sides of the structural frame, a plurality of mating features located about the frame members, and corner portions each comprising a corner fitting for connecting the transport platform assembly to a receiving arrangement of a transport vehicle, the method comprising: locating the unitarily arranged canopy assembly above the transport platform assembly, positioning the unitarily arranged canopy assembly such that complimentary features located about a bottom of the wall thereof are aligned with corresponding mating features at a side of the of the structural frame, and lowering the unitarily arranged canopy assembly atop the transport platform assembly and coupling the mating and complimentary features together so as to connect the unitarily arranged canopy assembly to the transport platform assembly.

In an embodiment, said coupling of the mating and complimentary features comprises arranging a fastener to extend through a primary receiving hole arranged about a side of the transport platform assembly and a through hole of the wall at a bottom thereof, and bolting it to said primary receiving hole and said through hole.

In an embodiment, said coupling of the mating and complimentary features comprises inserting a locating tube of the wall extending downwardly from the bottom thereof, into a vertical elongate tube receptacle arranged about a side of the transport platform assembly.

In an embodiment, said coupling of the mating and complimentary features comprises arranging a twist lock at and coaxially aligning it with a twist lock receiving aperture located on any of the corner portions and a twist lock receiving slot at the bottom of the wall, and locking it to said twist lock receiving aperture and said twist lock receiving slot.

In a third aspect, the invention provides a method for conveying loads, the method comprising: mounting and securing a load onto a pallet to obtain a loaded pallet; locating the loaded pallet on a load receiving platform of a transport platform assembly, the load receiving platform having a planar upper surface comprising and configured to receive a load thereon, and the transport platform assembly comprising: a generally rectangular structural frame configured to support the load receiving platform and comprising: first and second longitudinal frame members and third and fourth transverse frame members that intersect each other to form respective first to forth longitudinal and transverse sides of the structural frame, and corner portions each comprising a corner fitting for permitting the transport platform assembly to be secured onto a receiving arrangement associated with a transport vehicle; securing the loaded pallet to the load receiving platform by way of securing lashings, extending from lashing elements on the loaded pallet, to lashing features of the structural frame.

In an embodiment, the lashing features of the structural frame comprise at least one inboard lashing feature below the upper surface of the load receiving platform located substantially in a middle region of the transport platform assembly and extending along a length thereof, and at least one securing lashing is secured thereto via at least one access aperture extending through the load receiving platform for permitting access to the inboard lashing feature below the upper surface thereof.

In an embodiment, wherein the at least one access aperture comprises a plurality of access apertures arranged in a linear array along the load receiving platform and proximately above the inboard lashing feature, and wherein a plurality of securing lashings are secured to the inboard lashing feature via the plurality of access apertures.

In an embodiment, wherein the inboard lashing feature comprises a inboard elongate lashing member extending along a length of the structural frame.

In an embodiment, wherein the at least one securing lashing is secured to the inboard elongate lashing member at a location thereof proximate at least one inboard support rib extending transversely across the inboard elongate lashing member and configured to support the inboard elongate lashing member.

In an embodiment, wherein the lashing features of the structural frame comprise at least one periphery lashing feature located proximate the sides of the structural frame and below the load receiving platform, and at least one securing lashing is secured thereto via at least one periphery access aperture along the sides of the frame for permitting access to the periphery lashing feature.

In an embodiment, wherein the periphery lashing feature comprises a periphery elongate lashing member extending along at least a portion of any one or more of the frame members and/or a periphery cross lashing member extending across at least a portion of any one or more of the frame members.

In an embodiment, wherein the at least one securing lashing is secured to the periphery elongate lashing member at a location thereof proximate at least one periphery support rib extending transversely across the periphery elongate lashing member and configured to support the periphery elongate lashing member.

In an embodiment, the method further comprises the step of: using a lifting apparatus to lift the combination of the transport platform assembly with the loaded pallet secured thereon; placing the combination of the transport platform assembly and loaded pallet on a receiving arrangement associated with a transport vehicle; and securing the corner fittings at each corner portion of the structural frame to corresponding locking arrangements provided on the receiving arrangement.

Disclosed herein is a transport platform assembly for loading, conveying and storing loads, the transport platform assembly comprising: a load receiving platform having a planar upper surface configured to receive a load thereon; a generally rectangular structural frame configured to support the load receiving platform and comprising first and second longitudinal frame members and third and fourth transverse frame members that intersect each other to form respective first to forth longitudinal and transverse sides of the structural frame; and at least one inboard lashing feature below the upper surface of the load receiving platform for securing any loads positioned thereon to the transport platform assembly, the structural frame further comprising corner portions each comprising a corner fitting for permitting the transport platform assembly to be secured onto a receiving arrangement associated with a transport vehicle, wherein any one or more of the aforementioned embodiments of the first aspect may apply to the disclosed transport platform assembly.

In a fourth aspect, the invention provides a method for conveying loads, the method comprising: using a lifting apparatus to lift a transport platform assembly having a loaded pallet secured thereon; placing the combination of the transport platform assembly and loaded pallet on a receiving arrangement associated with a transport vehicle; and securing corner fittings at corner portions of the transport platform assembly to corresponding locking arrangements provided on the receiving arrangement.

In an embodiment, the method further comprises the step of unsecuring the corner fittings and corresponding locking arrangements, and using a lifting apparatus to lift the combination of the transport platform assembly and loaded pallet away from the receiving arrangement.

In an embodiment, the locking arrangements comprise twist locks and the corner fittings comprise corner castings configured to receive said twist locks for securing thereto.

In an embodiment, the method further comprises the step of transporting the combination of the transport platform assembly and loaded pallet by way of the transport vehicle.

In an embodiment, the transport platform assembly comprises a load receiving platform configured to receive a loaded pallet thereon, a generally rectangular structural frame configured to support the load receiving platform and comprising longitudinal and transverse sides, and a plurality of lashing features for securing a load to the transport platform assembly.

In an embodiment, the lashing features comprise at least one inboard lashing feature below an upper surface of the load receiving platform located at a middle region of the transport platform assembly, and the transport platform assembly comprises at least one access aperture extending through the load receiving platform for permitting access to the inboard lashing feature.

In an embodiment, the at least one access aperture comprises a plurality of access apertures arranged in a linear array along the load receiving platform and proximately above the inboard lashing feature.

In an embodiment, the at least one inboard lashing feature is located at a strengthening member located substantially in the middle region of the transport platform assembly and extending along a length thereof.

In an embodiment, the lashing features of the structural frame comprise at least one periphery lashing feature located proximate the sides of the structural frame and below the load receiving platform,

In an embodiment, the periphery lashing feature comprises a periphery elongate lashing member extending along at least a portion of any one or more of the sides of the structural frame and/or a periphery cross lashing member extending across at least a portion of any one or more of the sides of the structural frame.

Any one or more of the aforementioned embodiments of any one of the first, second, third or fourth aspect may apply to any other of the first, second, third or fourth aspects.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 shows a perspective schematic view of an embodiment transport platform assembly.

FIG. 2 shows a perspective schematic underside view of the embodiment transport platform assembly of FIG. 1.

FIG. 3A shows a perspective close up view of the underside of the embodiment transport platform assembly of FIG. 1.

FIG. 3B shows a perspective close up view of a side of the embodiment transport platform assembly of FIG. 1.

FIG. 4 shows a perspective schematic view of the embodiment transport platform assembly of FIG. 1 in use with a load secured thereon.

FIG. 5 shows a perspective schematic view of an embodiment transport platform assembly together with an embodiment canopy assembly.

FIG. 6A shows a perspective schematic view of a wall module of the embodiment canopy assembly of FIG. 5, together with the embodiment transport platform assembly.

FIG. 6B shows a schematic cutaway close up view of the wall module and embodiment transport platform assembly of FIG. 6A coupled together.

FIG. 6C shows a schematic close up view of a side of the embodiment transport platform assembly of FIG. 6A.

FIG. 7A shows a perspective schematic view of a ceiling module of the embodiment canopy assembly of FIG. 5.

FIG. 7B shows a schematic cutaway close up view of the ceiling module of FIG. 7A.

FIG. 7C shows a schematic cutaway close up view of the wall module of FIG. 6A.

FIGS. 8A and 8B show perspective schematic views of a plurality of embodiment transport assemblies in a horizontal and vertical orientation respectively.

FIG. 9 shows a perspective schematic view of an embodiment unitarily arranged canopy assembly.

### DETAILED DESCRIPTION OF PREFERRED EMBODIMENTS

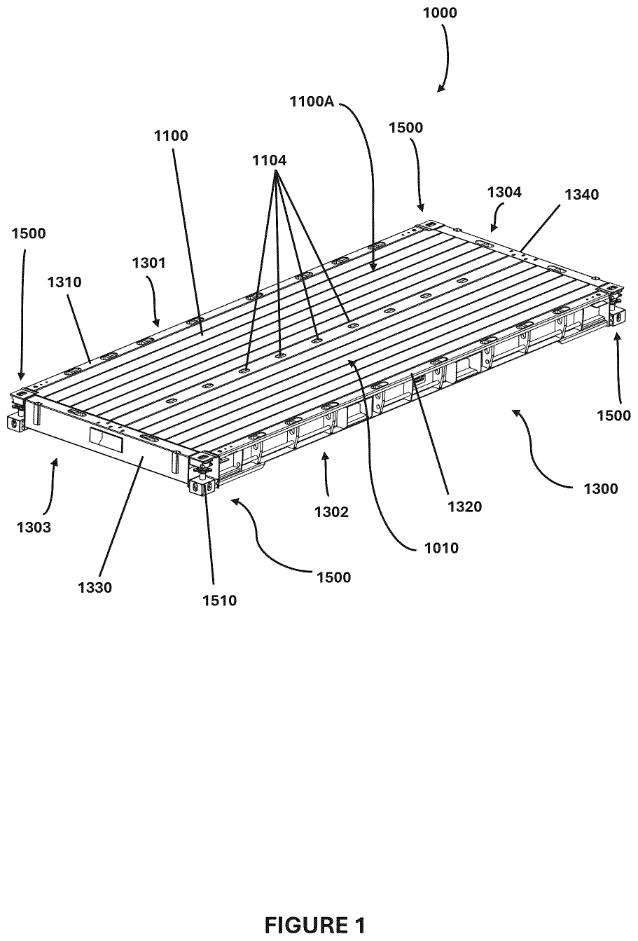

FIG. 1 shows an embodiment transport platform assembly 1000 for loading, conveying and storing loads. Where loads are referred to herein, they may generally be large discrete loads such as large pumps, motors and other valuable equipment, for which safe, reliable and secure means of loading, conveying and storage of such loads is desirable.

The transport platform assembly 1000 may be generally configured in a generally rectangular form, as shown, and may be configured to conform to a variety of known shipping and logistics standards, for reasons that will become evident in the foregoing description.

For example, the transport platform assembly 1000 may be generally configured to conform with the footprint, planform, width and/or length of a standard 20-foot shipping container, having a width of about 8 feet, or about 2.44 meters and a length of about 20 feet, or 6.06 meters.

In some embodiments, the transport platform assembly 1000 may be generally configured to conform with the footprint, planform, width and/or length of any other standard shipping container specification, such as that of a 10-feet, 20-feet and/or 40-feet shipping container.

The transport platform assembly 1000 may be generally configured to conform with the International Organization for Standardization (ISO) standards for shipping container dimensions and specifications, specifically ISO 668:2020.

The particular embodiment transport platform assembly 1000 shown may conform with the footprint, planform, width and/or length of a standard 20-foot shipping container, and comprises a length of about 6058 millimetres, a width of about 2438 millimetres and a height of about 343 millimetres.

The embodiment transport platform assembly 1000 comprises a load receiving platform 1100 having a planar upper surface 1100A. The planar surface 1100A may be configured to receive a load thereon.

In some embodiments, the upper surface 1100A may be substantially continuously planar, and may include no upwardly extending structures. Understood otherwise, the surface may not comprise any protrusions, surfaces or the like that extend upwardly in any manner that would potentially inhibit a flat loading of a load atop the upper surface 1100A. This is relevant where a load is first secured to a pallet, and the loaded pallet is then itself placed atop the upper surface 1100A. As the bottom surfaces of pallets are generally flat themselves, having a conformingly continuously flat upper surface 1100A provides stability to the loaded pallet so placed atop the load receiving platform 1100.

The embodiment transport platform assembly 1000 also comprises a generally rectangular structural frame 1300 configured to support the load receiving platform 1100 and comprising first and second longitudinal frame members 1310, 1320 and third and fourth transverse frame members 1330, 1340 that intersect each other to form respective first to forth longitudinal and transverse sides 1301, 1302, 1303, 1304 of the structural frame 1300.

In other words, the frame members 1310, 1320, 1330, 1340 may be understood to define the sides 1301, 1302, 1303, 1304 of the structural frame 1300. With reference to FIG. 1, the first and second longitudinal frame members 1310, 1320 evidently define the longer first and second sides 1301, 1302 of the structural frame 1300, and the third and fourth transverse frame members 1330, 1340 evidently define the shorter third and fourth sides 1303, 1304 of the structural frame.

The structural frame 1100 is also shown comprising additional longitudinal support members 1306, as well as additional transverse support members 1305, each arranged in rows beneath the load receiving platform 1100 to provide structural strength and rigidity thereto.

The structural frame 1100 further comprises corner portions 1500 each comprising a corner fitting 1510 for permitting the transport platform assembly 1000 to be secured onto a receiving arrangement associated with a transport vehicle.

The receiving arrangement may comprise a semi-trailer, associated with a semi-truck, for example, where such existing receiving arrangements are provided for transport of shipping containers, using i.e., semi-trucks.

A receiving arrangement which can be used to transport the embodiment transport platform assembly 1000 and other associated embodiments described herein may hence also be of a generally rectangular form, may also be configured to conform to a variety of known shipping and logistics standards.

The receiving arrangement may be generally configured to conform to receive, secure and transport a standard 20-foot shipping container, or any other standard shipping container specification, such as that of a 10-feet, 20-feet and/or 40-feet shipping container, and/or may be generally configured to conform to receive any shipping container configured in accordance with the International Organization for Standardization (ISO) standards for shipping container dimensions and specifications, specifically ISO 668:2020.

As such, when the term receiving arrangement is used herein, it may refer to any number of known or employed arrangement of transport vehicles for receiving, securing and then transporting shipping containers.

Understood otherwise, the embodiment transport platform assembly 1000 and other associated embodiments described herein may be effectively be configured to conform with shipping container specifications, such that it can be used to load, convey and/or store loads using infrastructure that is already adapted to load, convey and/or store shipping containers.

Since such infrastructure, including transport vehicles (i.e., semi-trucks, trailers thereof, larger wheeled vehicles, trains and train carriages, shipping vessels etc), hauling or lifting equipment (cranes, gantry systems), as well as logistics, shipping and/or storage facilities, are replete and common place, the embodiment transport platform assembly 1000 and associated embodiment methods described herein may provide ease of use and advantages in logistics, cost, shipping and labour as they can be adapted into said existing infrastructure without the need for customised equipment or non-standard workflows or procedures.

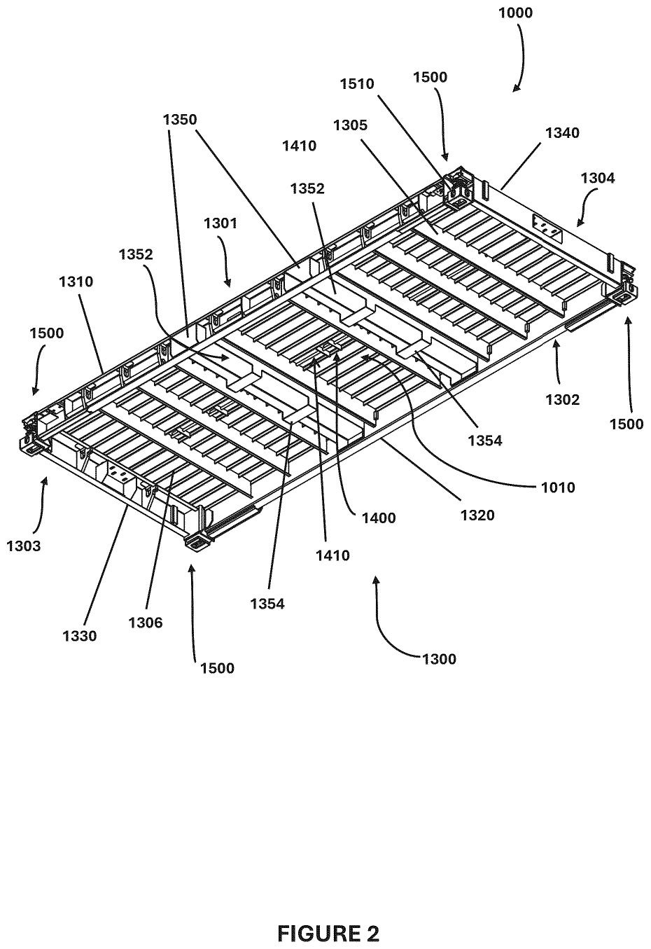

FIG. 2 shows an underside of the transport platform assembly 1000, where a strengthening member 1400 can be seen located substantially in a middle region 1010 of the transport platform assembly 1000 and extending along a length thereof.

The strengthening member 1400 may be provided to present at least one inboard lashing feature 1410 below the upper surface 1100A of the load receiving platform 1100, for securing any loads positioned thereon to the transport platform assembly 1000, as will be described in further detail below.

As will be generally appreciated in the foregoing description, the strengthening member 1400 may provide rigidity as well as lashing features for the transport platform assembly 1000, and so does not need to be positioned in a specific orientation or position relative the transport platform assembly 1000.

Therefore, in some embodiments, the strengthening member 1400 may be located generally anywhere in said middle region 1010 of the transport platform assembly 1000. The strengthening member 1400 may be off-set or closer to one or more sides 1301, 1302, 1303, 1304 of the structural frame 1300, in some embodiments.

In some embodiments, the strengthening member 1400 may be located centrally relative to the longitudinal sides 1301, 1302 of the structural frame 1300. In some embodiments, the strengthening member 1400, may be located and extend equidistantly between the longitudinal sides 1301, 1302 of the structural frame 1300.

In an embodiment, the structural frame 1300 comprises two or more spaced apart openings 1350 located below the load receiving platform 1100, the openings 1350 extending longitudinally and/or transversally across the structural frame 1300 and configured to receive tines of a forklift.

In FIG. 2, the embodiment transport platform assembly 1000 is shown having the two spaced apart openings 1350 extending transversally across the structural frame 1300. The openings 1350 are shown extending through both of the first and second longitudinal frame members 1310, 1320. In this manner, a forklift or other hauling equipment may approach the transport platform assembly 1000 from either longer side 1301, 1302 thereof.

The openings 1350 may communicate with or define elongate channels 1352 extending across the structural frame 1300, which channels 1352 are shown having lower crossmembers 1354 extending across them. The lower crossmembers 1354 may enhance the rigidity of the structural frame 1300 around said channels 1352, i.e., around where tines of a forklift may impart lifting or movement forces upon the structural frame 1300. The lower crossmembers 1354 may also serve as an anti-tipping countersurface to prevent the transport platform assembly 1000 from falling off the tines of a forklift during movement.

In an embodiment, the load receiving platform 1100 comprises at least one access aperture 1104 extending therethrough for permitting access to the inboard lashing feature 1410 below the upper surface 1100A thereof. As shown in FIG. 1, the at least one access aperture 1104 comprises a plurality of access apertures 1104 arranged in a linear array along the load receiving platform 1100 and proximately above the inboard lashing feature 1410.

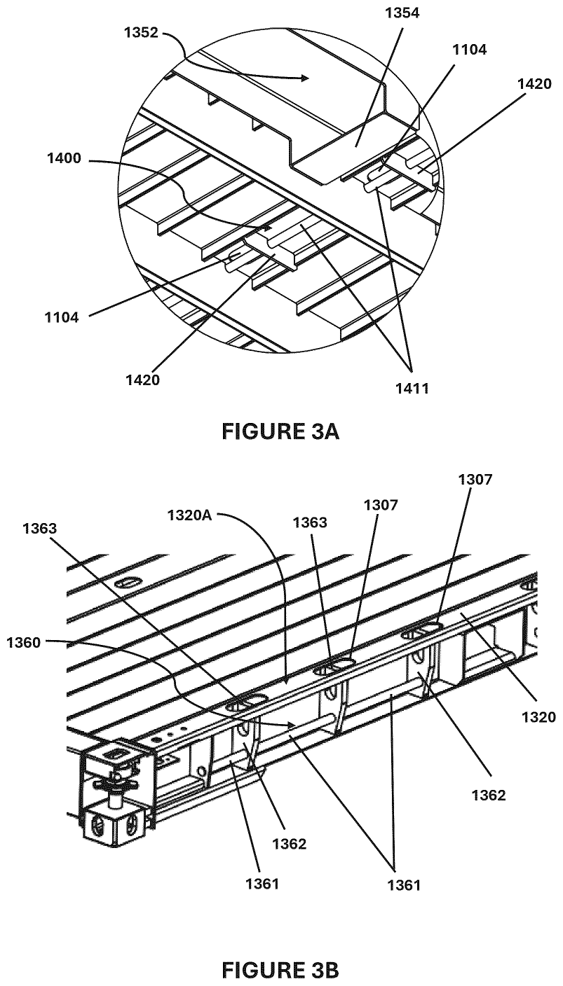

In an embodiment, as shown in FIG. 3A, the inboard lashing feature 1410 comprises a inboard elongate lashing member 1411 extending centrally longitudinally along at least a portion of the strengthening member 1400. The inboard elongate lashing member 1411 is shown as an elongate rod, formed from for example stainless steel or other metal or metal alloy. The access apertures 1104 of the load receiving platform 1100 are shown positioned substantially directly above portions of the inboard elongate lashing member 1411, so that securing lashings can be passed therethrough and fixedly secured to the inboard elongate lashing member 1411.

It will be appreciated that the inboard elongate lashing member 1411 may comprise a plurality of discrete rods, or may be continuously formed and then joined to the structural frame 1300. In any case, the inboard elongate lashing member(s) 1411 may provide a rigid and secure anchoring location for any securing lashings extending from a palletised load, or a pallet itself, placed atop the load receiving platform 1100.

In an embodiment, the strengthening member 1400 is shown having at least one inboard support rib 1420 extending transversely across the inboard elongate lashing member 1411 and configured to support the inboard elongate lashing member 1411. Said at least one inboard support rib 1420 is shown positioned proximate the access apertures 1104 of the load receiving platform 1100, so as to provide rigidity to the portion of the inboard elongate lashing member(s) 1411 employed in use to secure any loads positioned on the load receiving platform 1100 to the transport platform assembly. In this way, a lashing coupled to the inboard elongate lashing member(s) 1411, via the access aperture(s) 1104, is conveniently coupled proximate the inboard support rib 1420, and so is provided extra retainment rigidity.

In some embodiments, the strengthening member 1400 may be configured to provide additional rigidity to the structural frame 1300. In particular, as the inboard elongate lashing member(s) 1411 are shown extending along the strengthening member 1400 and may be employed to endure a substantial proportion of forces imparted by a load (via lashings transferring forces to the lashing member(s) 1411), it may be beneficial for the strengthening member 1400 to be strengthened to endure said forces.

This may be done in number of ways, such as by employing stronger or more rigid materials at or around the strengthening member 1400 and/or by attaching bolsters to the strengthening member 1400. In addition, at least portions of the additional longitudinal support members 1306, and additional transverse support members 1305, proximate the strengthening member 1400 may be hardened or strengthened, configured with larger thicknesses or likewise structurally enhanced to also provide further rigidity.

Where ‘inboard’ is used herein with reference to the inboard lashing feature(s) 1410, inboard elongate lashing member(s) 1411 and inboard support rib(s) 1420, it should be understood as being located generally anywhere inward of the sides 1301, 1302, 1303, 1304 of the structural frame 1300, i.e., towards a notional centre point of the transport platform assembly 1000.

In some embodiments, the inboard lashing feature(s) 1410, inboard elongate lashing member(s) 1411 and inboard support rib(s) 1420 may be located substantially in a middle region 1010 of the transport platform assembly 1000, in a similar manner to the strengthening member 1400.

Moreover, while a singular strengthening member 1400 has been described herein, more than one strengthening member 1400 may be provided or located substantially in the middle region 1010 of the transport platform assembly 1000.

A plurality of strengthening members, for example, may be located generally about the middle region 1010 of the transport platform assembly 1000, presenting a variety of different inboard lashing feature(s) 1410.

The plurality of strengthening members may be aligned axially, i.e., in a column extending along the length of the transport platform assembly 1000. They may also instead be oriented axially offset from one another, and one or more of them may be positioned more, or less proximate any one or more of the sides 1301, 1302, 1303, 1304 of the structural frame 1300 relative another strengthening member.

In any case, where a plurality of strengthening members is provided, they may provide structural support to the transport platform assembly 1000 and present a plurality of inboard lashing features 1410 to assist in securing loads positioned on the load receiving platform 1100. In some embodiments, a strengthening member 1400 may not be present, and instead, at least one inboard lashing feature 1410 may itself be located below the upper surface of the load receiving platform 1100, for securing any loads positioned thereon to the transport platform assembly. The skilled addressee may envisage a plurality of inboard lashing features 1410 located about the transport platform assembly 1000, i.e., about the middle region 1010 thereof, with a plurality of access apertures for permitting access thereto.

As shown in FIG. 3B, the structural frame 1300 may also comprise at least one periphery lashing feature 1360 located proximate the sides 1301, 1302, 1303, 1304 of the structural frame 1300 and below the load receiving platform 1100, for securing any loads positioned thereon to the transport platform assembly 1000. In an embodiment, the periphery lashing feature 1360 comprises a periphery elongate lashing member 1361 extending along at least a portion of any one or more of the frame members 1310, 1320, 1330, 1340.

While a periphery lashing feature 1360 may be located about any side of the structural frame 1300, FIG. 3B shows periphery lashing features 1360 arranged at the second longitudinal side 1302 of the structural frame 1300, i.e., at the second longitudinal frame member 1320. Also shown is the structural frame 1300 comprising at least one periphery access aperture 1307 for permitting access to the periphery lashing feature 1360, in particular, to periphery elongate lashing members 1361 extending along, and underneath an upper surface 1320A of, the second longitudinal side 1302 of the structural frame 1300.

As with the inboard elongate lashing members 1411, the periphery elongate lashing members 1361 may comprise a plurality of discrete rods, or may be continuously formed and then joined to the structural frame 1300. In any case, the periphery elongate lashing members 1361 may provide a rigid and secure anchoring location for any securing lashings extending from a palletised load, or a pallet itself, placed atop the load receiving platform 1100.

In an embodiment, the structural frame 1300 may also include at least one periphery support rib 1362 extending transversely across the periphery elongate lashing member 1361 and configured to support the periphery elongate lashing member 1361. As shown in FIG. 3B, a plurality of said periphery support ribs 1362 may be arranged along the periphery elongate lashing members 1361.

Similar to the inboard support ribs 1420, the periphery support rib 1362 may be positioned proximate the periphery access apertures 1307 of the structural frame 1300, so as to provide rigidity to the portion of the periphery elongate lashing member 1361 when employed in use to secure any loads positioned on the load receiving platform 1100 to the transport platform assembly 1000.

In some embodiments, the periphery lashing feature 1360 may also comprises a periphery cross lashing member 1363 extending across at least a portion of any one or more of the frame members 1310, 1320, 1330, 1340. In FIG. 3B, periphery cross lashing members 1363 can be seen extending across the second longitudinal frame member 1320.

In an embodiment, the periphery cross lashing member 1363 may form an upper portion of the at least one periphery support rib 1362.

In FIG. 3B, multiple periphery cross lashing members 1363 are shown integrally formed as part of upper portions of the multiple periphery support ribs 1362, which, similar to the inboard support ribs 1420, are themselves positioned beneath the periphery access apertures 1307. In this way, a securing lashing coupled to the periphery elongate lashing members 1361 and/or periphery cross lashing members 1363, via the periphery access apertures 1307, are conveniently coupled proximate (or to) the periphery support ribs 1362, and so is provided extra retainment rigidity.

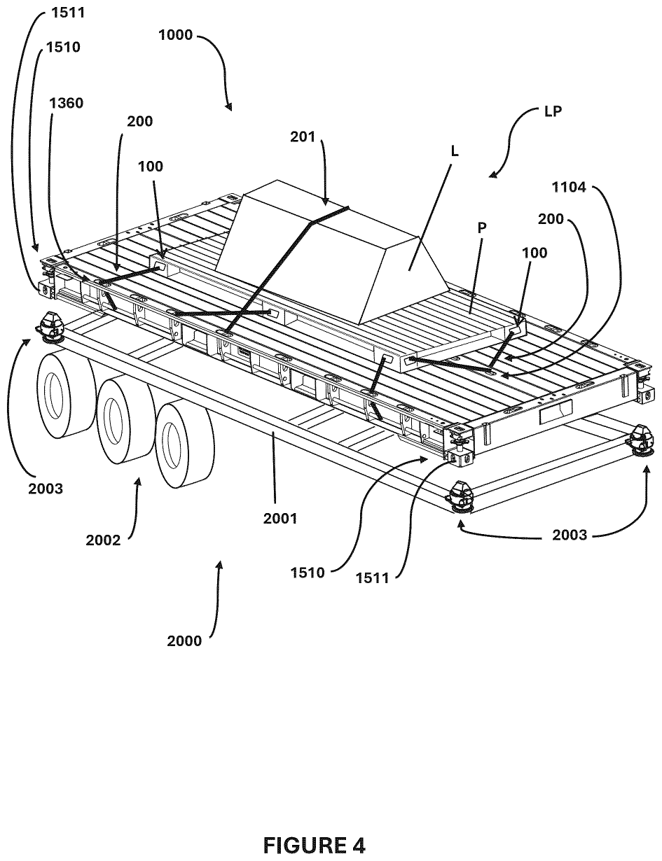

FIG. 4 schematically illustrates the embodiment transport platform assembly 1000 in use. A load (L) can be seen secured to a pallet (P) thereby forming a loaded pallet (LP). The load (L) may comprise a large and heavy item of machinery, for example, such as a pump or motor or gearbox. The pallet (P) and thereby loaded pallet (LP) is shown comprising lashing elements 100 arranged about the pallet (P). The pallet (P) shown is exemplary only and may comprise any known or typically configured pallet employed for conveying heavy or large loads. It may, for example, by a metallic pallet having a heavy weight rating (such as 3.5 tonnes or more). The lashing elements 100 may comprise apertures or openings, hooks, or any other suitable fastener or coupler receiving element typically provided on the structures of such pallets.

The loaded pallet (LP), which may also be referred to simply as a load throughout this specification, is received atop the load receiving platform 1100, i.e., engaged to the upper surface 1100A thereof. Securing lashings 200 are shown extending from the lashing elements 100 of the loaded pallet (LP) to both a central access aperture 1104 on the load receiving platform 1100, as well as to a plurality of periphery access apertures 1307 of the sides of the structural frame 1300. Accordingly, the loaded pallet (LP) is secured to at least one inboard lashing feature 1410, and to a plurality of periphery lashing features 1360.

It will be appreciated this setup is exemplary only, and an operator may select any position or number of central or periphery lashing features, as well as any of the access apertures thereof, when coupling the securing lashings 200. An operator may also choose in some instances to couple securing lashing 200 to a periphery elongate lashing member 1361, or to a periphery cross lashing member 1363 thereabove. Moreover, in some instances, a pallet may not be required or present, and a load may instead be placed directly atop the load receiving platform 1100.

In some embodiments, a securing lashing 200 may also not necessarily extend from or connect to a lashing element 200 of the loaded pallet (LP), but may instead simple contact the loaded pallet (LP), and be secured to any one of the lashing features of the structural frame 1300. For example, securing lashing 201 can be seen atop the load (L) and extending to periphery lashing features 1360, and would be tightened by way of a strap ratchet, for example, so as to impart a downward securing force onto the loaded pallet (LP) so as to securely engage it to the load receiving platform 1100.

Also shown in FIG. 4 is an example receiving arrangement 2000 associated with a transport vehicle. In this instance, the receiving arrangement 2000 may be what is referred to in the art as a container chassis, being a semi-truck trailer chassis generally comprising a frame 2001, movement means 2002 (i.e., wheels) and a plurality of locking arrangements 2003 arranged about the frame 2001. The locking arrangements 2003 may be arranged about the frame 2001 to conform to the four corners of a shipping container, such as a standard 20-foot shipping container. Accordingly, said locking arrangements 2003 may comprise ISO twist locks configured for insertion into and connection with corresponding matching corner castings of a shipping container.

As described previously, the transport platform assembly 1000 is advantageously configured to conform with shipping container infrastructure, so that it can be easily employed therewith for loading, conveying and storage of loads.

Therefore, the corner fitting 1510 which permit the transport platform assembly to be secured onto a receiving arrangement may comprise a twist lock arrangement configured to receive a twist lock for securing the transport platform assembly 1000 to corresponding locking arrangements 2003 of the receiving arrangement 2000.

In particular, the corner fittings 1510 may comprise corner castings 1511 which receive twist locks 2003 of the locking arrangements 2003, which twist locks 2003 may then be rotated to secure or lock the transport platform assembly 1000 to the receiving arrangement 2000.

While the embodiment transport platform assembly 1000 is shown in a raised position above the receiving arrangement 2000 in FIG. 4, for clarity purposes, the corner castings 1511 of each corner fitting 1510 thereof are shown aligned and above corresponding twist locks 2003 of the locking arrangements 2003 of the receiving arrangement 2000.

A method for conveying loads may hence be envisaged that takes advantage these benefits. The method may comprise first using a lifting apparatus to lift an embodiment transport platform assembly 1000 having a loaded pallet (LP) secured thereon, placing the combination of the transport platform assembly 1000 and loaded pallet (LP) on a receiving arrangement 2000 associated with a transport vehicle, and securing corner fittings 1510 at corner portions 1500 of the transport platform assembly 1000 to corresponding locking arrangements 2003 provided on the receiving arrangement.

As explained above, the locking arrangements 2003 may comprise twist locks and the corner fittings may comprise corner castings 1511 configured to receive said twist locks for securing thereto.

The method may further include the step of transporting the combination of the transport platform assembly 1000 and loaded pallet (LP) by way of the transport vehicle.

The method may further include the step of unsecuring the corner fittings 1510 and corresponding locking arrangements 2003, and using a lifting apparatus to lift the combination of the transport platform assembly 1000 and loaded pallet (LP) away from the receiving arrangement 2000.

The embodiment transport platform assembly 1000 may hence allow for easy loading and loading, and conveying/transport of loaded pallets (LP).

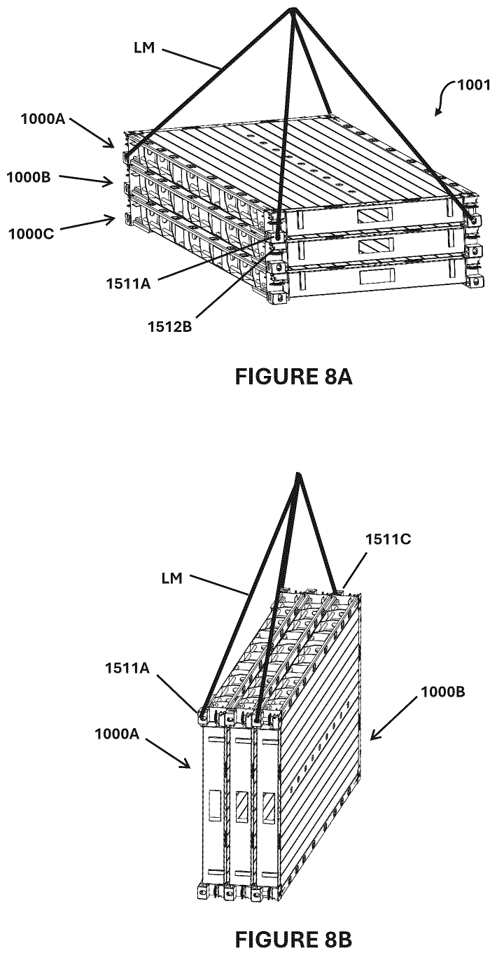

Moreover, as can be seen in FIGS. 8A and 8B, an embodiment transport platform assembly 1000 may be configured so that it is stackable to form a plurality of transport platform assemblies 1001 arranged atop one another, the corner fittings 1510 thereof configured to secure each transport platform assembly 1000 of the plurality of transport platform assemblies 1001 to an adjacent transport platform assembly.

In particular, as the corner fittings 1510 may comprise corner castings 1511 which receive twist locks 2003 of the locking arrangements 2003, said corner castings 1511 may equally receive twist locks 1512 mounted to adjacent transport platform assemblies, so that embodiment transport platform assemblies can be twist lock secured to one another.

Therefore, in an embodiment, the corner fittings 1510 may comprise a twist lock 1512 configured for insertion into a corner casting 1511 of another adjacent transport platform assembly, for securing the transport platform assembly to said other adjacent transport platform assembly.

This can be seen in FIG. 8A, where a twist lock 1512B of a centre-positioned transport platform assembly 1000B of the plurality of transport platform assemblies 1001 is coupled with the corner casting 1511A of an upper-positioned transport platform assembly 1000A of the plurality of transport platform assemblies 1001.

Moreover, in an embodiment, the corner portions 1500 of an embodiment transport platform assembly 1000 may be configured to receive a lifting attachment of a lifting apparatus such that the plurality of transport platform assemblies 1001 are together movable from at least four corner portions 1500 of the plurality of transport platform assemblies 1001.

In some instances, the plurality of transport platform assemblies 1001 may be movable by at least four corner portions 1500 thereof, (i.e., by at least four corner portions of any of the transport platform assemblies so forming the plurality 1001) when they are in a substantially horizontal orientation with the upper surfaces 1100A of their load receiving platforms 1100 oriented substantially horizontally (as shown in FIG. 8A), and/or in a substantially vertical orientation with their upper surfaces oriented substantially vertically (as shown in FIG. 8B).

This may be achieved in a number of ways. For example, in FIG. 8A, a lifting attachment, such as a clamp, of lifting means (LM) such as chains or cables of a lifting apparatus are shown connected to the eyelets of the corner castings 1511A of the upper-positioned transport platform assembly 1000A of the plurality of transport platform assemblies 1001 only. This may be suitable in instances where the stack is oriented horizontally as shown, and is desired to be moved in that orientation.

Alternatively, as seen in FIG. 8B, the lifting means (LM) are instead clamped to corner portions 1500A, 1500C of left and right-positioned transport platform assemblies 1000A, 1000C, of the plurality of transport platform assemblies 1001.

In some embodiments, lifting attachments of lifting means (LM) may connect to a twist lock receiving aperture 5006, or corner casting 1511, or other eyelet, aperture or the like located on any of the corner portions 1500.

It will be appreciated that a plurality of transport platform assemblies 1001 may be movable, conveyable or storable in either the horizontal or vertical orientation shown, providing further optionality to users thereof.

Moreover, in some embodiments, a plurality of transport platform assemblies 1001 may be first lifted in a vertical orientation as shown in FIG. 8B, before being lowered in a manner that places them into a horizontal orientation as shown in FIG. 8A. Thereafter, individual transport platform assemblies may either be removed from the plurality 1001, for subsequent use, or the plurality 1001 itself may be lifted and moved elsewhere in the horizontal orientation.

In some instances, a plurality of transport platform assemblies 1001 may be used for the loading, conveying or storage of a load, as a load could simply be placed atop an upper-most transport platform assembly (such as the upper-positioned transport platform assembly 1000A of FIG. 8A), secured thereto as described previously, and then the entire plurality 1001 including the load secured thereto could be lifted and lowered onto a receiving arrangement 2000 of a transport vehicle, with the corner fittings 1510C of the lower-positioned transport platform assembly 1000C of FIG. 8A, for example, receiving and locking with ISO twist locks 2003 of the receiving arrangement 2000. In this way, a load may be stored or transported, together with some spare transport platform assemblies, if desired.

It will be appreciated from FIG. 4 and the aforementioned description of the embodiment transport platform assembly 1000, how said assembly provides potential benefits in the loading, conveying, and storage of loads. Not only does it serve as a modular and interchangeable means of conveying loads, but it also does so in a manner that adapts and conforms to shipping container infrastructure that is replete in logistics industries. A load may therefore, by way of the transport platform assembly 1000, be easily loaded onto, and unloaded from existing semi-truck trailers (i.e., shipping container chassis'), for example, and using existing equipment (i.e., forklifts, cranes etc.) that is nominally adapted for loading and unloading shipping containers.

Moreover, transport to destinations may be facilitated by existing means for transporting shipping containers. It will be appreciated that transport vehicles other than semi-trucks may receive embodiment transport platform assemblies 1000, such as trains or sea-borne vessels and the like, which may also comprise ISO twist lock arrangements and the like as part of their receiving arrangements for securing shipping containers, and an embodiment transport platform assembly 1000 thereto. In any case, transport vehicles may not require any modification or alteration in order to suitably receive and transport a transport platform assembly 1000 and load thereon.

Finally, in some instances, a load may be placed into storage while still atop and secured to a transport platform assembly 1000. Since the transport platform assembly 1000 is dimensioned to conform with shipping container sizes, the logistics of appropriately storing the transport platform assembly 1000 in a storage facility may be relatively straightforward since the facility is itself configured with shipping container dimensions in mind. Similarly, storage of the transport platform assemblies themselves may also be convenient, as they can be stacked and stored in locations already adapted with shipping container dimensions in mind.

All of these potential benefits may also be imparted onto the storage and transport of the transport platform assemblies themselves, as described with reference to the plurality transport platform assemblies 1001 of FIGS. 8A and 8B.

With reference to the aforementioned description of FIGS. 1 to 4, a method for conveying loads may be provided.

The method may include mounting and securing a load (L) onto a pallet (P) to obtain a loaded pallet (LP), and then locating the loaded pallet (LP) on a load receiving platform 1100 of a transport platform assembly 1000.

The load receiving platform 1100 may have a planar upper surface 1100A configured to receive a load thereon, and the transport platform assembly 1000 may comprise a generally rectangular structural frame 1300 configured to support the load receiving platform 1100 and comprising: first and second longitudinal frame members 1310, 1320 and third and fourth transverse frame members 1330, 1340 that intersect each other to form respective first to forth longitudinal and transverse sides 1301, 1302, 1303, 1304 of the structural frame 1300, and corner portions 1500 each comprising a corner fitting 1510 for permitting the transport platform assembly 1000 to be secured onto a receiving arrangement 2000 associated with a transport vehicle.

The transport platform assembly 1000 may comprise the embodiment transport platform assembly 1000 herein described, and may include all of its features, in some embodiments.

The method may further include securing the loaded pallet (LP) to the load receiving platform 1100 by way of securing lashings 200, extending from lashing elements 100 on the loaded pallet (LP), to lashing features 1360, 1410 of the structural frame 1300.

The lashing features 1360, 1410 of the structural frame 1300 may comprise at least one central lashing 1410 feature below the upper surface 1100A of the load receiving platform 1100 located centrally relative to the longitudinal sides 1301, 1302 of the structural frame 1300 and extending along a length thereof, and at least one securing lashing 200 is secured thereto via at least one access aperture 1104 extending through the load receiving platform 1100 for permitting access to the inboard lashing feature 1410 below the upper surface 1100A thereof.

Moreover, the at least one access aperture 1104 may comprise a plurality of access apertures 1104 arranged in a linear array along the load receiving platform 1100 and proximately above the inboard lashing feature 1410, and wherein a plurality of securing lashings 200 are secured to the inboard lashing feature 1410 via the plurality of access apertures 1104.

In an embodiment, the inboard lashing feature 1410 may comprise a inboard elongate lashing member 1411 extending along a length of the structural frame. Moreover, the at least one securing lashing may be secured to the inboard elongate lashing member 1411 at a location thereof proximate at least one inboard support rib 1420 extending transversely across the inboard elongate lashing member 1411 and configured to support the inboard elongate lashing member.

In an embodiment, the lashing features of the structural frame 1300 may include at least one periphery lashing feature 1360 located proximate the sides 1301, 1302, 1303, 1304 of the structural frame 1300 and below the load receiving platform 1100, and at least one securing lashing 200 is secured thereto via at least one periphery access aperture 1307 along the sides 1301, 1302, 1303, 1304 of the frame 1300 for permitting access to the periphery lashing feature 1360.

The periphery lashing feature 1360 may comprise a periphery elongate lashing member 1361 extending along at least a portion of any one or more of the frame members 1310, 1320, 1330, 1340 and/or a periphery cross lashing member 1363 extending across at least a portion of any one or more of the frame members 1310, 1320, 1330, 1340.

In an embodiment, at least one securing lashing 200 may be secured to the periphery elongate lashing member 1361 at a location thereof proximate at least one periphery support rib 1362 extending transversely across the periphery elongate lashing member 1361 and configured to support the periphery elongate lashing member.

In an embodiment, the method further comprises the step of: using a lifting apparatus to lift the combination of the transport platform assembly 1000 with the loaded pallet (LP) secured thereon, placing the combination of the transport platform assembly 1000 and loaded pallet (LP) on a receiving arrangement 2000 associated with a transport vehicle, and securing the corner fittings 1510 at each corner portion 1500 of the structural frame 1300 to corresponding locking arrangements 2003 provided on the receiving arrangement 2000.

In particular, the combination of the transport platform assembly 1000 and loaded pallet (LP) may be lowered so that twist locks 2003 of the receiving arrangement 2000 insert into corner castings 1511 of the corner portions 1510 of the transport platform assembly 1000, for subsequent locking thereof.

It will be appreciated that this method can be carried out by securing lifting attachments, such as clamps or hooks, of a lifting apparatus, such as a crane, to the corner portions 1500 of the transport platform assembly 1000, as described with respect to FIGS. 8A and 8B.

Moreover, standard equipment may be used to carry out this method, such as a crane or gantry system adapted to move and lift shipping containers, given the transport platform assembly's 1000 conformity with shipping container infrastructure that is replete in logistics industries, as described above.

In that sense, it will be appreciated that any of the advantages and benefits described above with respect to the embodiment transport platform assembly 1000 may be equally imparted onto the aforementioned method for loading, conveying and storing loads.

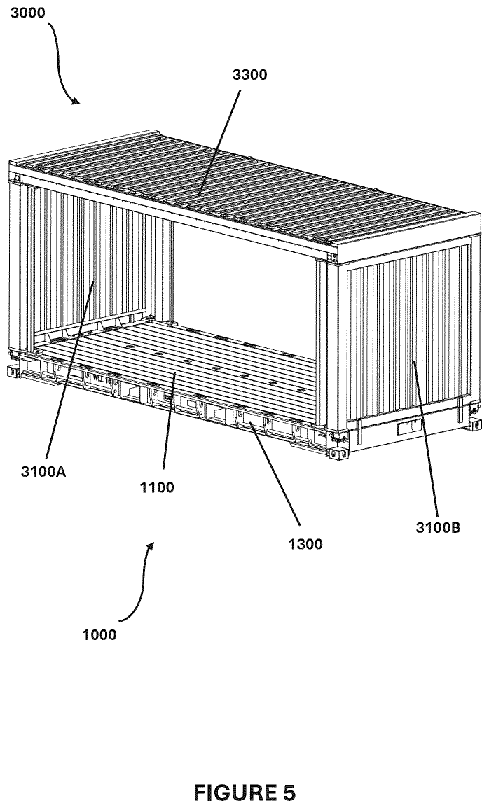

FIG. 5 shows an embodiment canopy assembly 3000 that may form part of, or be used together with the embodiment transport platform assembly 1000.

In some embodiments, the transport platform assembly 1000 may include a plurality of mating features 5000 arranged about the load receiving platform 1100 and/or structural frame 1300.

The canopy assembly 3000 may include at least one wall module 3100 and at least one ceiling module 3300 and a plurality of complementary features 4000 adapted to interface with corresponding mating features 5000 of the transport platform assembly 1000, so as to form the canopy assembly 3000 atop the transport platform assembly.

The canopy assembly 3000 may therefore be provided as an assemblable protective housing for a load received by the transport platform assembly 1000. In FIG. 5, two substantially symmetrical and mirrored wall modules 3100A, 3100B, and a single ceiling module 3300 is shown. However, in some embodiments, four wall modules may be provided to completely enclose a load. Moreover, in some embodiments, an open side (O) of the canopy assembly may be provided by a canvas or other non-rigid covering, for protecting a load from the elements, for example.

In any case, the transport platform assembly 1000 and canopy assembly 3000 are together configured such that each of the wall module(s) 3100 and ceiling module 3300 can be sequentially mated to the transport platform assembly 1000 for so forming the canopy assembly 3000.

In some embodiments, the transport platform assembly 1000 and canopy assembly 3000 are together configured to permit said sequential mating to the transport platform assembly 1000, while said transport platform assembly 1000 is secured to a receiving arrangement 2000. In other words, the plurality of complementary features 4000 and plurality of mating features 5000 may be arranged and configured so that even as the transport platform assembly 1000 is securely locked to a receiving arrangement (such as the shipping container chassis trailer 2000 of FIG. 4, for example), the canopy assembly 3000 can be sequentially mated to the transport platform assembly 1000 without having to first remove or unload the transport platform assembly 1000 from the receiving arrangement 2000.

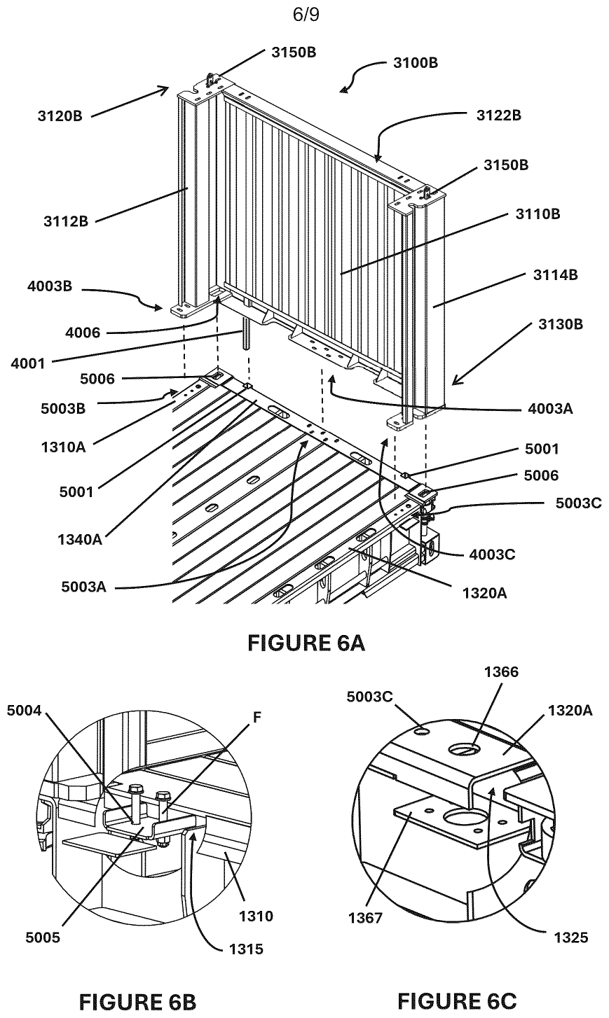

FIGS. 6A to 6C show the embodiment wall module 3100B, which features and functionality thereof apply equally to substantially mirrored wall module 3100A. The wall module 3100B generally comprises a main wall portion 3110B, and two flank portions 3112B, 3114B. A top 3120B and bottom 3130B of the wall module may also be defined. Lifting points 3150 may also be provided at the top 3120B of the wall module 3100B so that couplings or hooks of a crane or other lifting equipment can connect to for movement of the wall module 3100B.

As can be seen in FIG. 6A, the mating features 5000 of the transport platform assembly 1000 may comprise a vertical elongate tube receptacle 5001 and/or a primary receiving hole 5003 arranged about the sides of the structural frame 1300. In particular, the vertical elongate tube receptacle 5001 may extend at least partly through, and the primary receiving hole 5003 may be located on an upper surface of, any one or more of the frame members. In the embodiment of FIG. 6A, two vertical elongate tube receptacles 5001 are shown extending partly through the fourth transverse frame member 1340, and an array of primary receiving holes 5003A is located on the upper surface 1340A of the fourth transverse frame member 1340. Moreover, two further pairs of primary receiving holes 5003B, 5003C are shown located on the upper surfaces 1310A, 1320A of the first and second longitudinal frame members 1310, 1320, proximate the fourth transverse frame member 1340.

The complementary features 4000 may comprise a downwardly extending locating tube 4001 and/or a through hole 4003 arranged about the bottom 3130B of the at least one wall module 3100B. In particular, two downwardly extending locating tubes 4001 are provided at the main wall portion 3110B, for each of the two vertical elongate tube receptacles 5001 (though one is not visible in FIG. 6A).

Moreover, a first array of array of through holes 4003A is shown corresponding to the array of primary receiving holes 5003A of the fourth transverse frame member 1340, and is also provided at the main wall portion 3110B. Two further pairs of through holes 5003B, 5003C are shown corresponding to the pairs of primary receiving holes 5003B, 5003C of the first and second longitudinal frame members 1310, 1320, and are provided at the flank portions 3112B, 3114B of the wall module 3100B.

In some embodiments, the mating features 5000 may further comprise an auxiliary receiving hole 5004 coaxial the primary receiving hole(s) 5003A, 5003B, 5003C and located on a flange member 5005 positioned beneath the upper surface of any one or more of the frame members, with the flange member located within a channel of any one or more of the frame members.

In particular, as shown in FIG. 6B, a pair of auxiliary receiving holes 5004 are shown beneath and coaxial the pair of primary receiving holes 5003B of the first longitudinal frame member 1310, and the flange member 5005 is shown located within a channel 1315 of the first longitudinal frame member 1310 beneath its upper surface 1310A. The same arrangement may be provided for the pair of primary receiving holes 5003C of the second longitudinal frame member 1320, and also for the array of primary receiving holes 5003A of the fourth transverse frame member 1340, if desired. For instance, a channel 1325 of the second longitudinal frame member 1320 can be seen in FIG. 6C, beneath its upper surface 1320A.

FIG. 6C also shows a canvas shaft aperture 1366 extending through the second longitudinal frame member 1320, and coaxially aligned with a ratchet plate 1367 therebeneath. Such canvas shaft aperture 1366 and ratchet plate 1367 can be located on both ends of the first and second longitudinal frame members 1310, 1320, as they are together configured to receive a canvas shaft to be mounted thereto in a vertical orientation, which canvas shafts are configured to support canvases that may extend to cover the openings of the canopy assembly 3000, with the ratchet plates 1367 allowing a ratchet to be mounted and used to retract and tension a canvas as desired.

In an embodiment, the mating features 5000 and complementary features 4000 are configured to receive at least one fastener (F) for extending through each of the through hole(s) 5003A, 5003B, 5003C, primary receiving hole(s) 5003A, 5003B, 5003C and auxiliary receiving hole(s) 5004, each coaxially aligned when coupling the wall module 3100B to the transport platform assembly 1000.

As can be seen in FIG. 6B for example, two fasteners (F) extend through the pair of primary receiving holes 5003B of the first longitudinal frame member 1310, the pair of auxiliary receiving holes 5004 and flange member 5005, and are bolted so as to provide a coupling engagement between the bottom of the flank portion 3112B of the wall module 3100B, the upper surface 1310A of the first longitudinal frame member 1310, and the flange member 5005 therebelow. This provides a reinforced secure coupling of the wall module 3100B to the transport platform assembly 1000.

Moreover, the two downwardly extending locating tubes 4001 and two vertical elongate tube receptacles 5001 may assist in guiding and coaxially aligning the aforementioned complementary features 4000 (arranged at the bottom of the wall module 3100B) to the corresponding mating features 5000 of the structural frame 1300, when lowering the wall module 3100B atop the transport platform assembly 1000.

In an embodiment, the mating features 5000 further comprise a twist lock receiving aperture 5006 located on any of the corner portions 1500, and the complementary features 4000 further comprise a twist lock receiving slot 4006 at the bottom of the at least one wall module. In particular, as can be seen in FIG. 6A, the embodiment transport platform assembly 1000 includes a twist lock receiving aperture 5006 on each of the corner portions 1500 shown, and the wall module 3100B includes two twist lock receiving slots 4006 at the bottom of each flank portions 3112B, 3114B thereof (with only one visible in FIG. 6A).

The twist lock receiving aperture 5006 and twist lock receiving slot 4006 are configured to coaxially align when mating the wall module 3100B to the transport platform assembly 1000 so as to together receive a twist lock positioned vertically in use and extending therethrough for securing the wall module to the transport platform assembly. In particular, a twist lock may be provided to protrude from upper surfaces of the corner portions 1500 of the transport platform assembly 1000, rotated into a first wall module receiving orientation aligned with for insertion into the twist lock receiving slots 4006 of the wall module, as the wall module is lowered onto the structural frame 1300, and then rotated into a locked orientation obstructing the twist lock receiving slots 4006 so that the wall module cannot be lifted upwards.

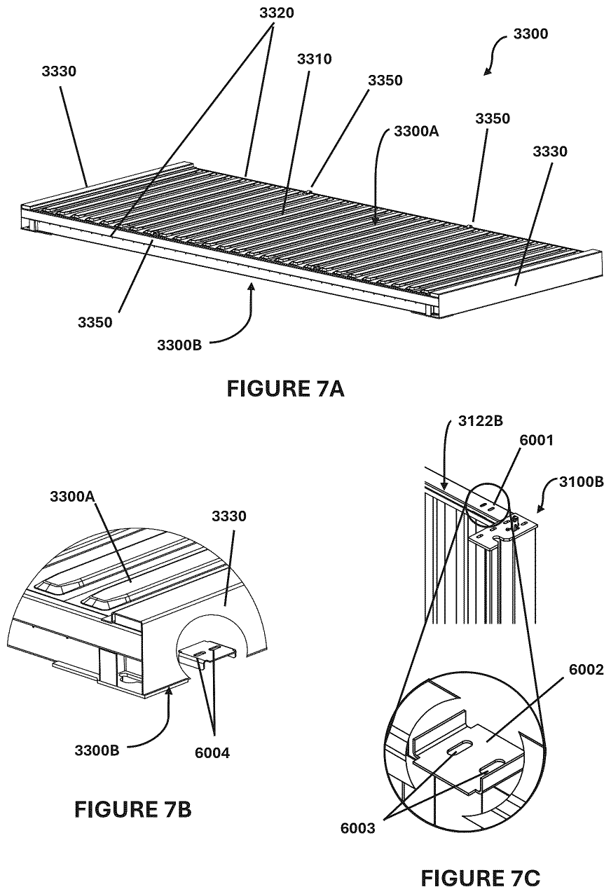

FIGS. 7A to 7C illustrate features of the embodiment canopy assembly 3000, and in particular the at least one ceiling module 3300. The ceiling module 3300 generally comprises a main portion 3310, longitudinal side members 3320, and transverse side members 3330, as well as a top surface 3300A and a bottom surface 3300B. Lifting points 3350 may also be provided at the top surface 3300A of the ceiling module 3300 so that couplings or hooks of a crane or other lifting equipment can connect to for movement of the ceiling module 3300.

In an embodiment, the canopy assembly 3000 comprises coupling features 6000 for interfacing and connecting the at least one ceiling module 3300 to the at least one wall module 3100A, 3100B.

The coupling features 6000 may comprising at least one coupling hole 6001 arranged at a top surface of the at least one wall module 3100A, 3100B, at least one coupling flange 6002 positioned beneath a top surface of the wall module 3122A, 3122B and comprising a supporting hole 6003 coaxial the coupling hole 6001, and at least one ceiling hole 6004 located about a bottom surface of the ceiling module 3300.

FIG. 7B shows a pair of ceiling holes 6004 located about a bottom surface 3300B of the ceiling module, in particular located on the transverse side member 3300 of the ceiling module 3300.

FIG. 7C illustrates a pair of coupling holes 6001 at the top surface 3122B of the wall module 3100B, as well as a coupling flange 6002 positioned beneath said top surface 3122B, comprising a pair of supporting holes 6003 coaxial the coupling holes 6001.

In an embodiment, the coupling features are configured to receive at least one fastener for extending through each of the ceiling hole 6004, coupling hole 6001 and supporting hole 6003 which are coaxially aligned when coupling the ceiling module 3300 to the wall module 3100A, 3100B, for coupling thereof. Therefore, in use, fasteners may extend through each of these holes and be bolted to provide a coupling engagement between the bottom surface 3300B of the ceiling module 3300, the top surface 3122A, 3122B of the wall module 3100A, 3100B, and the coupling flange 6002 positioned beneath said top surface 3122B. This provides a reinforced secure coupling of the ceiling module 3300 to the wall module 3100A, 3100B.

It will be appreciated that the aforementioned configurations of the various mating, coupling and complementary features 4000, 5000, 6000 are exemplary only, and the positioning and relationships between the various features can be modified by a skilled person while achieving relatively similar functionality of assembling the canopy assembly 3000.

It will also be appreciated that where any feature of the wall module 3100B has been described, equivalent and mirrored features may be provided to the other wall module 3100A, and their functionality with respect to the various mating, coupling and complementary features 4000, 5000, 6000 may be the same.

In some embodiments, a canopy assembly may be provided comprising the aforementioned features and functions described with reference to FIGS. 5 to 7C, but as an already-assembled unitary arrangement of the wall module(s) 3100A, 3100B and ceiling module 3300 connected together, the already-assembled unitary arrangement canopy assembly then simply lowered atop an embodiment transport platform assembly 1000, with the mating and complementary features 4000, 5000 of the wall module(s) 3100A, 3100B and transport platform assembly 1000 then coupled together to couple the unitary arrangement canopy assembly to the transport platform assembly 1000.

Further, the skilled addressee will appreciate that in some embodiments, the canopy assembly may not necessarily comprise separate wall and ceiling modules sequentially mated to the transport platform assembly 1000 for so forming the canopy assembly 3000, but may instead comprise wall and ceiling portions already connected, or unitarily formed with one another.

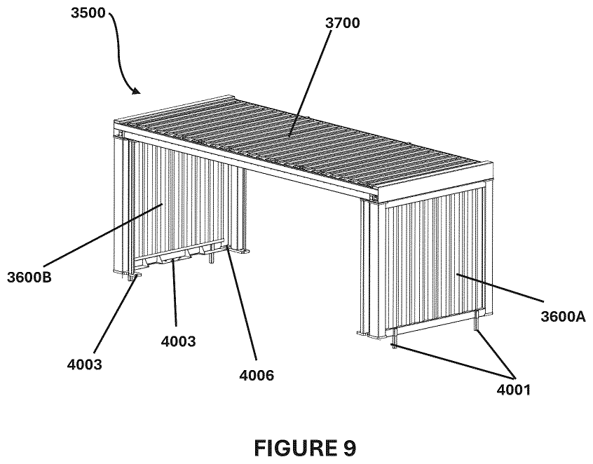

To that end, in an embodiment, the transport platform assembly 1000 may comprises a plurality of mating features 4000 arranged about the load receiving platform 1100 and/or structural frame 1300, and further comprising a unitarily arranged canopy assembly 3500, as shown in FIG. 9, comprising at least one wall 3600A, 3600B and at least one ceiling 3700 connected or unitarily formed together, and configured for connecting to the transport assembly 1000 by way of a plurality of complementary features 5000 thereof adapted to interface with corresponding mating features 4000.

The wall 3600A, 3600B and ceiling 3700 may be configured in a similar manner to the wall module(s) and ceiling module(s) of the canopy assembly 3000 of FIGS. 5 to 7C. They may be already connected or unitarily formed together by way of the coupling features 6000 previously described, or otherwise formed together unitarily by fastening, bolting, or welding the wall 3600A, 3600B and ceiling 3700 together, or even casting or manufacturing them initially as a single piece by any suitable means known in the art.

In some embodiments, the mating and complementary features 4000, 5000 may be as described above with reference to FIGS. 5 to 7C.

For instance, as shown in FIG. 9, the complimentary features 4000 of the unitarily arranged canopy assembly 3500 may comprise through hole(s) 4003 of the walls 3600A, 3600B at bottoms 3630A, 3630B thereof, locating tube(s) 4001 of the walls 3600A, 3600B extending downwardly from the bottoms 3630A, 3630B thereof, and twist lock receiving slot(s) 4006 at the bottoms 3630A, 3630B of the walls 3600A, 3600B.

These complimentary features 4000 may interface with the mating features 5000 of the embodiment transport platform assembly 1000 as described above with reference to FIGS. 5 to 7C, i.e., wherein fastener(s) couple the primary receiving hole(s) 5003 with said through hole(s) 4003, said locating tube(s) 4001 insert into the vertical elongate tube receptacle(s) 5001, and wherein twist lock(s) are arranged coaxially into the twist lock receiving aperture(s) 5006 and twist lock receiving slot(s) 4006, to couple the unitarily arranged canopy assembly 3500 to the embodiment transport platform assembly 1000.

It will be appreciated that the above described embodiment canopy assemblies 3000, 3500 may also provide benefits in the transport and storage of the canopy assemblies 3000, 3500 themselves. For instance, the overall canopy assembly 3000, 3500, being configured to conform with the transport platform assembly 1000 having at least planform (i.e., length and width) dimensions of a shipping container, may likewise itself comprise or conform with standardized dimensions of a shipping container. For instance, a height or width of a combination transport platform assembly 1000 and canopy assembly 3000, 3500, as shown in FIG. 5 for example, may be similar to that of a standard 20-foot shipping container.

Moreover, the modular and removable wall and ceiling modules may be stacked, stored and/or transported efficiently, as they might also generally comprise heights, widths or lengths that coincide with standardized dimensions of a shipping container.

The potential benefits of the transport platform assembly 1000 described above, with respect to its adaptation to standard shipping container infrastructure, may also apply equally to the canopy assemblies 3000, 3500, when in their assembled state atop the transport platform assembly 1000, and/or when in a disassembled or partially assembled state.

In view of the aforementioned description of FIGS. 5 to 7C, a method of coupling a canopy assembly 3000 to a transport platform assembly 1000 for loading, conveying and storing loads, may also be provided.

The transport platform assembly 1000 may comprise a load receiving platform 1100, a generally rectangular structural frame 1300 supporting the load receiving platform 1100 and comprising frame members 1310, 1320, 1330, 1340 defining sides of the structural frame 1300, a plurality of mating features located about the frame members, and corner portions 1500 each comprising a corner fitting 1510 for connecting the transport platform assembly 1000 to a receiving arrangement 2000 of a transport vehicle.

The transport platform assembly 1000 may be as described or may also comprise the embodiment transport platform assembly 1000 of FIGS. 1 to 8B.

The method may include locating a first wall module 3100A, 3100B of the canopy assembly above a side 1301, 1302, 1303, 1304 of the structural frame 1300 and positioning the wall module 3100A, 3100B such that complimentary features 4001, 4003, 4006 located about a bottom 3130A, 3130B of the wall module 3100A, 3100B are aligned with corresponding mating features 5001, 5003, 5006 at the side 1301, 1302, 1303, 1304 of the structural frame 1300. This locating above and positioning of the wall module 3100A, 3100B may be carried out by appropriate lifting means attached to the lifting points 3150A, 3150B of the wall module 3100A, 3100B.

Thereafter, the method may employ lowering the wall module 3100A, 3100B atop the transport platform assembly 1000 and coupling the mating and complimentary features 4001, 4003, 4006, 5001, 5003, 5006 together so as to connect the wall module 3100A, 3100B to the side 1301, 1302, 1303, 1304 of the transport platform assembly 1000.

Thereafter, the method may include locating a second wall module 3100A, 3100B of the canopy assembly 3000 above another side 1301, 1302, 1303, 1304 of the structural frame 1300 and positioning the second wall module 3100A, 3100B such that complimentary features 4001, 4003, 4006 located about a bottom of the second wall module are aligned with corresponding mating features 5001, 5003, 5006 at the other side 1301, 1302, 1303, 1304 of the structural frame 1300.

Thereafter, the second wall module 3100A, 3100B may be lowered atop the transport platform assembly 1000 and the mating and complimentary features 4001, 4003, 4006, 5001, 5003, 5006 may be coupled together so as to connect the second wall module 3100A, 3100B to the other side 1301, 1302, 1303, 1304 of the transport platform assembly 1000.

The method may then include locating a ceiling module 3300 of the canopy assembly 3000 above the so connected first and second wall modules 3100A, 3100B, positioning the ceiling module 3300 such that coupling features 6001, 6002, 6003, 6004, of the ceiling module and of each of the first and second wall modules 3100A, 3100B are aligned, and lowering the ceiling module 3300 and connecting the coupling features 6001, 6002, 6003, 6004 so as to connect the ceiling module 3300 to the so connected first and second wall modules 3100A, 3100B.

This may substantially form the canopy assembly 3000 atop the transport platform assembly 1000 as shown in FIG. 5, for example.

In an embodiment, the coupling of the mating and complimentary features 4001, 4003, 4006, 5001, 5003, 5006 comprises arranging a fastener (F) to extend through a primary receiving hole 5003 arranged about a side of the transport platform assembly and a through hole 4003 of the first or second wall module 3100A, 3100B located at a bottom 3130A, 3130B thereof, and bolting it to said primary receiving hole 5003 and said through hole 4003.

In an embodiment, said coupling of the mating and complimentary features 4001, 4003, 4006, 5001, 5003, 5006 comprises inserting a locating tube 4001 of the first or second wall module 3100A, 3100B extending downwardly from the bottom 3130A, 3130B thereof, into a vertical elongate tube receptacle 5001 arranged about a 1301, 1302, 1303, 1304 of the transport platform assembly 1000.

In an embodiment, said coupling of the mating and complimentary features 4001, 4003, 4006, 5001, 5003, 5006 comprises arranging a twist lock at, and coaxially aligning it with, a twist lock receiving aperture 5006 located on any of the corner portions 1500 and a twist lock receiving slot 4006 at the bottom 3130A, 3130B of the first or second wall module 3100A, 3100B, and locking it to said twist lock receiving aperture 5006 and said twist lock receiving slot 4006.

In an embodiment, said connecting of the coupling features 6001, 6002, 6003, 6004 to connect the ceiling module 3300 to the so connected first and second wall modules 3100A, 3100B comprises arranging a fastener (F) to extend through a coupling hole 6001 arranged at a top surface of the first or second wall module 3100A, 3100B, and a ceiling hole 6004 located about a bottom surface 3300B of the ceiling module 3300, and bolting it to said coupling hole 6001 and ceiling hole 6004.

It will be appreciated that further wall modules can be coupled to the transport platform assembly 1000, to form a third or fourth wall of the canopy assembly.

The features, functionality and potential benefits described above with respect to the embodiment canopy assembly 3000 may apply equally to the aforementioned method of assembling the same.

Moreover, as described previously, a unitarily arranged canopy assembly 3500 comprising at least one wall 3600A, 3600B and at least one ceiling 3700 connected or unitarily formed together, may be provided, and therefore, so too may a method for assembly thereof with a transport platform assembly.

Therefore, in an embodiment, there may be provided a method of coupling a unitarily arranged canopy assembly 3500 to a transport platform assembly 1000 for loading, conveying and storing loads, the unitarily arranged canopy assembly may comprise at least one wall 3600A, 3600B and at least one ceiling 3700 connected or unitarily formed together, and the transport platform assembly 1000 may comprise a load receiving platform 1100, a generally rectangular structural frame 1300 supporting the load receiving platform 1100 and comprising frame members 1310, 1320, 1330, 1340 defining sides of the structural frame 1300, a plurality of mating features located about the frame members, and corner portions 1500 each comprising a corner fitting 1510 for connecting the transport platform assembly 1000 to a receiving arrangement 2000 of a transport vehicle. The transport platform assembly 1000 may be as described or may also comprise the embodiment transport platform assembly 1000 of FIGS. 1 to 8B.

The method may include locating the unitarily arranged canopy assembly 3500 above the transport platform assembly 1000, positioning the unitarily arranged canopy assembly such that complimentary features 4000 located about a bottom of the wall 3600A, 3600B thereof are aligned with corresponding mating features 5000 at a side of the of the structural frame 1300, and lowering the unitarily arranged canopy assembly 3500 atop the transport platform assembly and coupling the mating and complimentary features together so as to connect the unitarily arranged canopy assembly to the transport platform assembly.

In compliance with the statute, the invention has been described in language more or less specific to structural or methodical features. The term “comprises” and its variations, such as “comprising” and “comprised of” is used throughout in an inclusive sense and not to the exclusion of any additional features.

It is to be understood that the invention is not limited to specific features shown or described since the means herein described comprises preferred forms of putting the invention into effect.

The invention is, therefore, claimed in any of its forms or modifications within the proper scope of the appended claims appropriately interpreted by those skilled in the art.

1. A transport platform assembly for loading, conveying and storing loads, the transport platform assembly comprising:
a load receiving platform having a planar upper surface configured to receive a load thereon;
a generally rectangular structural frame configured to support the load receiving platform and comprising first and second longitudinal frame members and third and fourth transverse frame members that intersect each other to form respective first to forth longitudinal and transverse sides of the structural frame; and
a strengthening member located substantially in a middle region of the transport platform assembly and extending along a length thereof, the strengthening member being provided to present at least one inboard lashing feature below the upper surface of the load receiving platform for securing any loads positioned thereon to the transport platform assembly, the structural frame further comprising corner portions each comprising a corner fitting for permitting the transport platform assembly to be secured onto a receiving arrangement associated with a transport vehicle.

2. The transport platform assembly of claim 1, wherein the load receiving platform comprises at least one access aperture extending therethrough for permitting access to the inboard lashing feature below the upper surface thereof.

3. The transport platform assembly of claim 2, wherein the at least one access aperture comprises a plurality of access apertures arranged in a linear array along the load receiving platform and proximately above the inboard lashing feature.

4. The transport platform assembly of claim 1, wherein the structural frame comprises at least one periphery lashing feature located proximate the sides of the structural frame and below the load receiving platform for securing any loads positioned thereon to the transport platform assembly.

5. The transport platform assembly of claim 1, wherein the transport platform assembly comprises a plurality of mating features arranged about the load receiving platform and/or structural frame, the transport platform assembly further comprising a canopy assembly comprising at least one wall module and at least one ceiling module and a plurality of complementary features adapted to interface with corresponding mating features of the transport platform assembly, so as to form the canopy assembly atop the transport platform assembly.

6. The transport platform assembly of claim 5, wherein the transport platform assembly and canopy assembly are together configured such that each of the wall module and ceiling module can be sequentially mated to the transport platform assembly for so forming the canopy assembly.

7. The transport platform assembly of claim 1, wherein the transport platform assembly is configured so that it is stackable to form a plurality of transport platform assemblies arranged atop one another, the corner fittings thereof configured to secure each transport platform assembly of the plurality of transport platform assemblies to an adjacent transport platform assembly.

8. The transport platform assembly of claim 7, wherein the corner portions are configured to receive a lifting attachment of a lifting apparatus such that the plurality of transport platform assemblies are together movable from at least four corner portions of the plurality of transport platform assemblies.

9. The transport platform assembly of claim 8, wherein the plurality of transport platform assemblies are movable by at least four corner portions thereof, when they are in a substantially horizontal orientation with the upper surfaces of their load receiving platforms oriented substantially horizontally, and/or in a substantially vertical orientation with their upper surfaces oriented substantially vertically.

10. The transport platform assembly of claim 1, wherein the corner fittings comprise a twist lock arrangement configured to receive a twist lock for securing the transport platform assembly to corresponding locking arrangements of the receiving arrangement.

11. A method for conveying loads, the method comprising:
using a lifting apparatus to lift a transport platform assembly having a loaded pallet secured thereon;
placing the combination of the transport platform assembly and loaded pallet on a receiving arrangement associated with a transport vehicle; and
securing corner fittings at corner portions of the transport platform assembly to corresponding locking arrangements provided on the receiving arrangement.

12. The method of claim 11, further comprising the step of unsecuring the corner fittings and corresponding locking arrangements, and using a lifting apparatus to lift the combination of the transport platform assembly and loaded pallet away from the receiving arrangement.

13. The method of claim 11, wherein the locking arrangements comprise twist locks and the corner fittings comprise corner castings configured to receive said twist locks for securing thereto.

14. The method of claim 11, further comprising the step of transporting the combination of the transport platform assembly and loaded pallet by way of the transport vehicle.

15. The method of claim 11, wherein the transport platform assembly comprises a load receiving platform configured to receive a loaded pallet thereon, a generally rectangular structural frame configured to support the load receiving platform and comprising longitudinal and transverse sides, and a plurality of lashing features for securing a load to the transport platform assembly.

16. The method of claim 15, wherein the lashing features comprise at least one inboard lashing feature below an upper surface of the load receiving platform located at a middle region of the transport platform assembly, and the transport platform assembly comprises at least one access aperture extending through the load receiving platform for permitting access to the inboard lashing feature.

17. The method of claim 16, wherein the at least one access aperture comprises a plurality of access apertures arranged in a linear array along the load receiving platform and proximately above the inboard lashing feature.

18. The method of claim 16, wherein the at least one inboard lashing feature is located at a strengthening member located substantially in the middle region of the transport platform assembly and extending along a length thereof.

19. The method of claim 15, wherein the lashing features of the structural frame comprise at least one periphery lashing feature located proximate the sides of the structural frame and below the load receiving platform.

20. The method of claim 19, wherein the periphery lashing feature comprises a periphery elongate lashing member extending along at least a portion of any one or more of the sides of the structural frame and/or a periphery cross lashing member extending across at least a portion of any one or more of the sides of the structural frame.
